(19) United States
(12) Patent Application Publication
(10) Pub. No.: US 2003/0043015 A1
(43) Pub. Date: Mar. 6, 2003

(54) Matrix switcher with three-dimensional orientation of printed circuit boards

(76) Inventor: Jack Gershfeld, Fullerton, CA (US)

Correspondence Address: LAW OFFICES OF VLADIMIR KHITERER, 2102 BUSINESS CENTER DR, SUITE 130, IRVINE, CA, 92612, US

(21) Appl. No.: 09/939,978

(22) Filed: Aug. 28, 2001

(51) Int. Cl. H04Q 1/00

(52) U.S. Cl. 340/2.28

(57) ABSTRACT

A matrix switcher with three-dimensional orientation of printed circuit boards is disclosed. The matrix switcher of the present invention has a number of input printed circuit boards each comprising a matrix input and a number of output printed circuit 5 boards each comprising a matrix output. Plains of the input printed circuit boards are substantially parallel to each other. Plains of the output printed circuit boards are also substantially parallel to each other and at the same time substantially perpendicular to the plains of the input printed circuit boards. Switches are located on either the input printed circuit boards or the output printed circuit boards. A signal can be sent from any matrix input to any matrix output by way of placing the corresponding switches in an “on” position. The three-dimensional orientation of the input and output printed circuit boards of the present invention eliminates stubs, makes layout of connecting wires on the printed circuit boards easy, does not require large layout area and reduces the problem of crosstalk.

### BACKGROUND OF THE INVENTION

This invention is in the area of electronics, and more specifically, it relates to a matrix switcher with three-dimensional orientation of printed circuit boards. Matrix switchers are widely used in applications requiring signal routing and distribution from multiple input sources to multiple output devices. For example, a video presentation system may include several input sources, such as video cameras, VCRs, computers and the like, and several output devices, such as computer monitors, projectors, etc. A matrix switcher would be used to connect the input sources to output devices and distribute and manipulate signals between inputs and outputs in desired combinations. This is accomplished by way of switching means connected to inputs and outputs contained in a matrix switcher, which can be turned “on” or “off” depending on the need.

Ideally, the quality of signals transmitted by a matrix switcher remains the same after the signal is applied to the input of a matrix switcher, routed through the matrix and received at the output of the matrix switcher. In practice, the quality of signals transmitted by a matrix switcher deteriorates to some degree. The higher the frequency of the signals transmitted by a matrix switcher, the more difficult it is to preserve signals free of degradation. The ongoing straggle in the audio visual industry is to design a matrix switcher that can handle high frequency signals, large number of inputs and outputs, and at the same time minimize degradation of the signals.

### BRIEF DESCRIPTION OF THE DRAWINGS FIGURES

FIG. 1, FIG. 2 and FIG. 3 are diagrams of the various matrix switchers of the prior art.

FIG. 4 is a diagram of the matrix switcher of the present invention FIG. 5 and FIG. 6 are diagrams of the preferred embodiments of the matrix switcher of the present invention.

### DETAILED DESCRIPTION OF THE DRAWINGS FIGURES

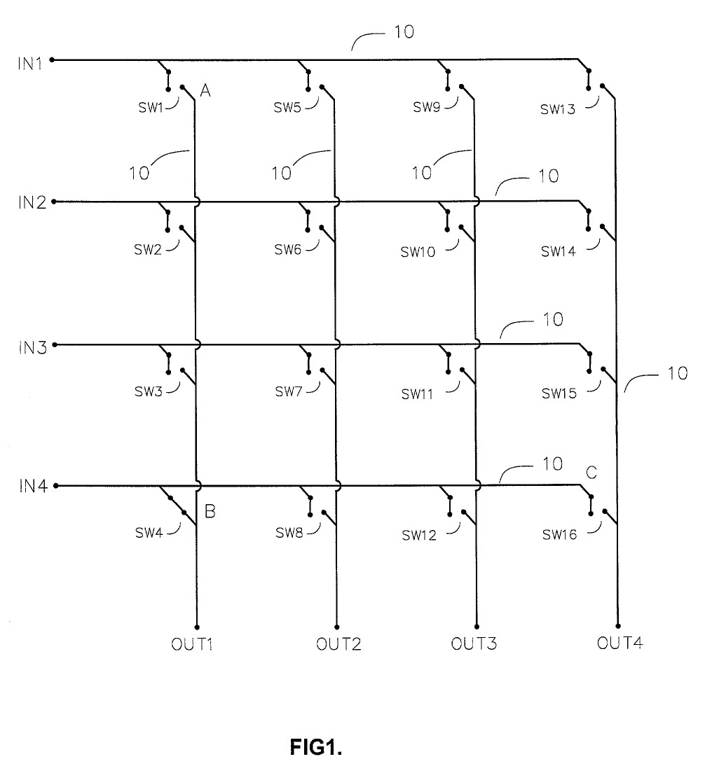

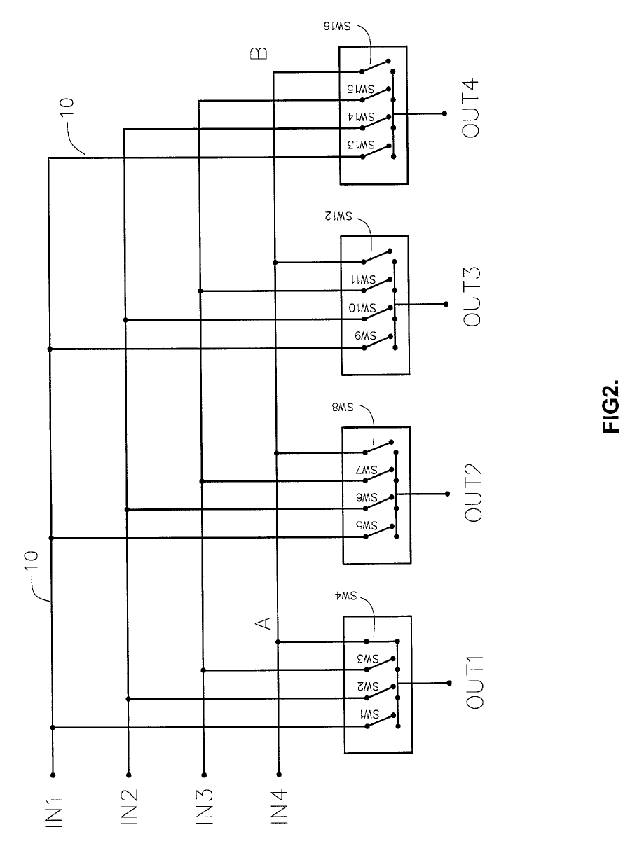

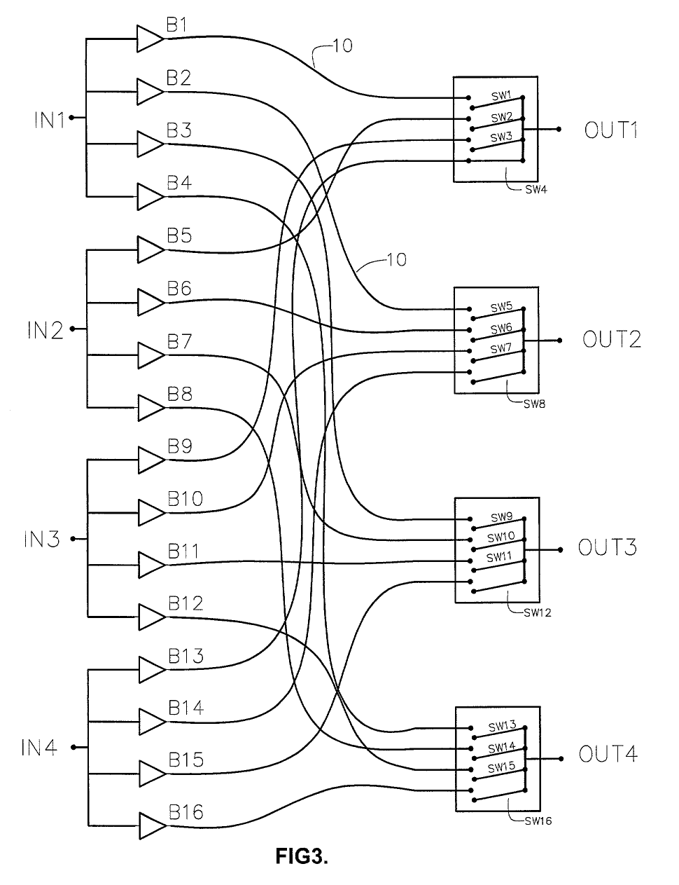

This invention will be better understood with first reviewing the disadvantages existing in the various matrix switchers of the prior art. The prior art will be reviewed with the reference to the drawing figures FIG. 1, FIG. 2 and FIG. 3. The same numerals and letters refer to the same elements in all drawing figures.

Referring to FIG. 1, there is shown a diagram of a 4×4 matrix switcher of the prior art. This matrix switcher has four inputs and four outputs. Letters and numerals IN1, IN2, IN3 and IN4 indicate, respectively, input 1, input 2, input 3 and input 4. Letters and numerals OUT1, OUT2, OUT3 and OUT4 indicate, respectively, output 1, output 2, output 3 and output 4. Numeral 10 indicates connecting wires. Letters and numerals SW1 through SW16 indicate switches. Inputs IN1, IN2, IN3, IN4, outputs OUT1, OUT2, OUT3, OUT4 and switches SW1 through SW16 are connected by connecting wires 10 in a way that connecting wires 10 form a grid (or “matrix”) with switches SW1 through SW16 located at the “knots” of the grid. Each of the switches SW1 through SW16 can be turned in an “on” or “off” position. Switch SW4 is shown in FIG. 1 in the “on” position. All other switches SW1 through SW16 are shown in the “off” position.

If switch SW4 is turned in the “on” position, and all other switches SW1 through SW16 are turned in the “off” position (as shown in FIG. 1), a signal applied to the input IN4 will travel from the input IN4 to the output OUT1. Similarly, turning switches SW1 through SW16 in the “on” or “off” position allows signals to travel from any of the inputs IN1, IN2, IN3, IN4 to any of the outputs OUT1, OUT2, OUT3, OUT4 in desired combinations.

However, the design of this particular matrix switcher presents the following disadvantages:

(a) Even though this design is acceptable for transmitting signals of low frequencies, transmitting signals of high frequencies presents problems due to the phenomenon known as “stubs”. Specifically, when switch SW4 is turned in the “on” position, portions of the connecting wire between points A and B, as well as between points B and C in FIG. 1, create stubs which interfere with and degrade the quality of signals transmitted by the matrix switcher. Portion of the connecting wire between points A and B is known as a “vertical stub” and portion of the connecting wire between points B and C is known as a “horizontal stub”. The same phenomena occurs when any of the switches SW1 through SW16 is turned in the “on” position.

(b) Even though this design is acceptable for a small (such as 4×4) matrix switcher, physical layout of the switches on printed circuit boards (“PCB”) becomes difficult for larger size matrix switchers.

(c) Connecting more outputs causes loading to increase, which also degrades the quality of signals transmitted by the matrix switcher.

Viewing now FIG. 2, there is shown a diagram of another 4×4 matrix switcher of the prior art. This matrix switcher has four inputs and four outputs. However, unlike the matrix switcher shown in FIG. 1, the matrix switcher shown in FIG. 2 has four switchers for each output, one for each of the four inputs. Specifically, switches SW1, SW2, SW3 and SW4 correspond, respectively, to the inputs IN1, IN2, IN3 and IN4. Similarly, switches SW5, SW6, SW7 and SW8 correspond, respectively, to the inputs IN5, IN6, IN7 and IN8 and so forth through the switch SW16.

Switch SW4 is shown in FIG. 2 in the “on” position. All other switches SW1 through SW16 are shown in the “off” position. If switch SW4 is turned in the “on” position, and all other switches SW1 through SW16 are turned in the “off” position (as shown in FIG. 2), a signal applied to the input IN4 will travel from the input IN4 to the output OUT1. Similarly, turning switches SW1 through SW16 in the “on” or “off” position allows signals to travel from any of the inputs IN1, IN2, IN3, IN4 to any of the outputs OUT1, OUT2, OUT3, OUT4 in desired combinations.

The matrix switcher shown in FIG. 2 does not have vertical stubs, which is an advantage over the matrix switcher shown in FIG. 1. However, this design still presents the following disadvantages:

(a) Horizontal subs remain. Specifically, if switch SW4 is turned in the “on” position, there is a horizontal stub between points A and B in FIG. 2. Further, horizontal stubs are longer because connecting wires 10 run longer distances.

(b) Connecting wires 10 in horizontal direction run longer distances in parallel, which causes the phenomenon known as “crosstalk”. Crosstalk interferes with and degrades the quality of signals transmitted by the matrix switcher.

Viewing now FIG. 3, there is shown a diagram of a yet another 4×4 matrix switcher of the prior art. This matrix switcher has four inputs and four outputs. Similarly, to the matrix switcher shown in FIG. 2, matrix switcher shown in FIG. 3 has four switchers for each output, one for each of the four inputs. Specifically, switches SW1, SW2, SW3 and SW4 correspond, respectively, to the inputs IN1, IN2, IN3 and IN4. Similarly, switches SW5, SW6, SW7 and SW8 correspond, respectively, to the inputs IN5, IN6, IN7 and IN8 and so forth through the switch SW16.

As in the matrix switcher shown in FIG. 2, switch SW4 is shown in FIG. 3 in the “on” position. All other switches SW1 through SW16 are shown in the “off” position. If switch SW4 is turned in the “on” position, and all other switches SW1 through SW16 are turned in the “off” position (as shown in FIG. 3), a signal applied to the input IN4 will travel from the input IN4 to the output OUT1. Similarly, turning switches SW1 through SW16 in the “on” or “off” position allows signals to travel from any of the inputs IN1, IN2, IN3, IN4 to any of the outputs OUT1, OUT2, OUT3, OUT4 in desired combinations.

However, unlike the matrix switcher shown in FIG. 2, the matrix switcher shown in FIG. 3 has each of its inputs IN1 through IN4 connected to four buffers B1 through B16. Buffer B1 of the input IN1 is connected to the switch SW1. Buffer B2 of input IN1 is connected to the switch SW1, etc.

The buffers B1 through B16 connected to the inputs IN1 through IN4 in the matrix switcher shown in FIG. 3 allow to eliminate horizontal and vertical stubs, which is an advantage over the matrix switcher shown in FIG. 2. Nevertheless, the matrix switcher shown in FIG. 3 has the following disadvantages:

(a) Connecting wires 10 in horizontal and vertical direction run longer distances in parallel, causing large crosstalk.

(b) Locating the switches and connecting wires 10 on a PCB requires large layout area, especially if the number of inputs and outputs increases.

(c) Layout of connecting wires 10 on a PCB becomes very challenging, especially if the number of inputs and outputs increases. Specifically, viewing FIG. 3, which shows the matrix switcher with only four inputs and four outputs (4×4), demonstrates the complexity of a layout of the connecting wires. It can be only imagined what the connecting wires layout would look like for a 16X16 or larger matrix switcher. Clearly, the connecting wires layout may become be so complex as to be impracticable.

(d) Larger layout area causes signals to travel longer distances, causing additional degradation.

The above overview of the prior art clearly demonstrates the need for a matrix switched that provides the following advantages:

(a) Eliminates stubs;

(b) Makes layout of connecting wires on printed circuit boards easy;

(c) Does not require large layout area.

(d) Reduces the problem of crosstalk.

### OBJECT AND SUMMARY OF THE INVENTION

The present invention is directed to a matrix switcher with three-dimensional orientation of printed circuit boards that provides the advantages discussed above.

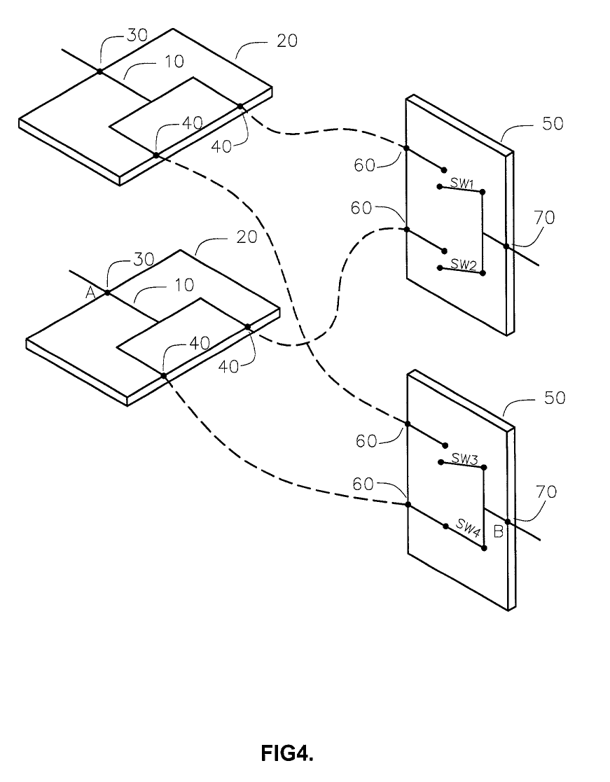

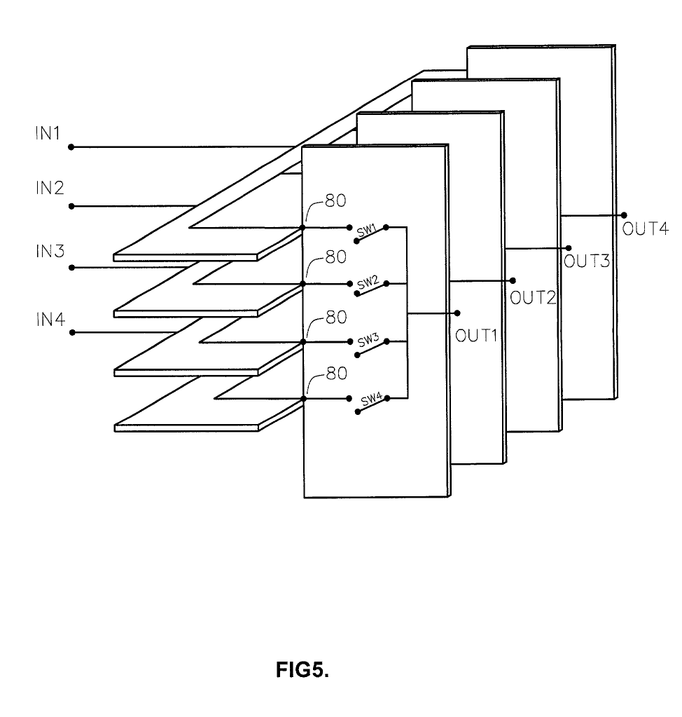

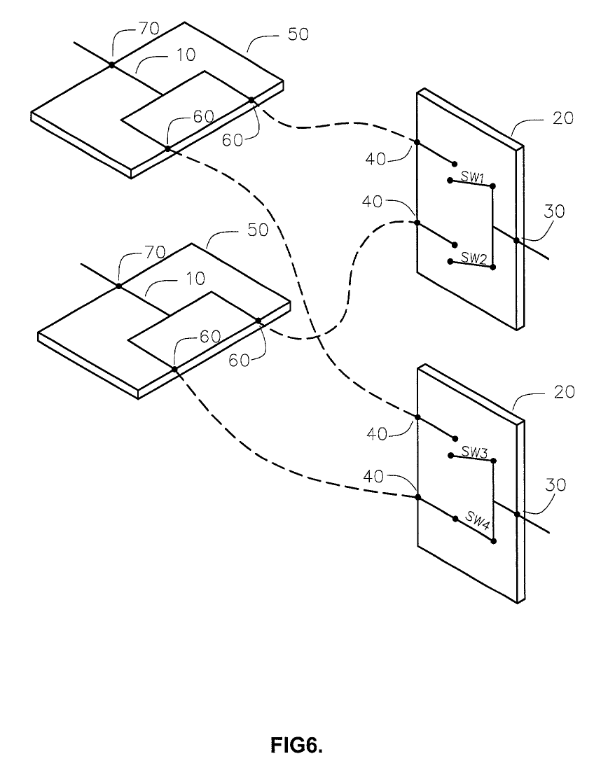

Viewing FIG. 4, there is shown a diagram of the matrix switcher of the present invention. For the sake of simplicity, FIG. 4 shows a 2×2 matrix switcher. Viewing the left side of FIG. 4, numeral 20 indicates an Input Printed Circuit Board. There are shown two Input Printed Circuit Boards 20 disposed in a way that their planes are substantially parallel to each other. Numeral 30 indicates a Matrix Input, each of the Input Printed Circuit Boards 20 comprises one Matrix Input 30. Numeral 40 indicates an Output. Each of the Input Printed Circuit Boards 20 comprises two Outputs 40, which are connected to the Matrix Input 30.

Viewing the right side of FIG. 4, numeral 50 indicates an Output Printed Circuit Board. There are shown two Output Printed Circuit Boards 50 disposed in a way that their planes are substantially parallel to each other, and at the same time substantially perpendicular to the planes of the Input Printed Circuit Boards 20. Numeral 60 indicates an Input. Each of the Output Printed Circuit Boards 50 comprises two Inputs 60.

Still viewing the right side of FIG. 4, each of the Output Printed Circuit Boards 50 comprises two Switches, SW1 and SW2 on one Output Printed Circuit Board 50 and SW3 and SW4 on the other. Numeral 70 indicates a Matrix Output. Each of the Output Printed Circuit Boards 50 comprises one Matrix Output 70. Each of the Inputs 70 is connected to one of the Switches and each of the Switches is connected to the Matrix Output 70.

Each of the Outputs 40 is connected to one Input 60. Further, the Input Printed Circuit Boards 20 on the left of FIG. 4 and the Output Printed Circuit Boards 50 on the right of FIG. 4 are shown wide apart (and connected by dotted lines) for the ease of explanation only. The Outputs 40 and the Inputs 60 are normally close together since the Input Printed Circuit Boards 20 and the Output Printed Circuit Boards 50 are connected to each other.

The Switches SW1, SW2, SW3 and SW4 can be placed in an “on” position and in an “off” position. When placed in the “on” position, the Switch permits a signal to pass through it, while in the “off” position, the Switch does not permit a signal to pass through it, thus permitting the signal from any of the Matrix Inputs 30 to be sent to any of the Matrix Outputs 70 via the corresponding Switches placed in the “on” position.

Specifically, Switch SW4 is shown in FIG. 4 in the “on” position. As such, a signal applied to Matrix Input 70 at point A will travel through the corresponding Output 40, Input 60, Switch SW4 and will be received at Matrix Output 70 at point B. Similarly, placing switches SW1 through SW4 in the “on” or “off” position allows signals to travel from any of the Matrix Inputs 30 to any of the Matrix Outputs 70 in desired combinations. As should be apparent to the persons knowledgeable in the pertinent art, the orientation of the input and output printed circuit boards shown in FIG. 4 eliminates stubs, makes layout of connecting wires on the printed circuit boards easy, does not require large layout area and reduces the problem of crosstalk.

Viewing FIG. 5, there is shown a diagram of the matrix switcher of a preferred embodiment of the present invention. FIG. 5 shows a 4×4 matrix switcher. It has four Input Printed Circuit Boards 20 and four Output Printed Circuit Boards 50 which are connected to each other at the points of Outputs 40 and Inputs 60, which allows to connect Outputs 40 and Inputs 60 by way of connectors rather than connecting wires.

It should be apparent that Switches can be disposed in the Input Printed Circuit Boards rather than in the Output Printed Circuit Boards without a change in how the matrix switcher of the present invention operates. Specifically, FIG. 6 can be used to illustrate locating Switches in the Input Printed Circuit Boards. Viewing FIG. 6, the Switches SW1, SW2, SW3 and SW4 are located in the Input Printed Circuit Boards 20 rather than in the Output Printed Circuit Boards 50. As can be seen, a signal applied to any of the Matrix Inputs 30 can be sent to any of the Matrix Outputs 70 by way of placing the corresponding Switches in the “on” position.

It should also be apparent that the matrix switcher of the present invention can have any number of the Input Printed Circuit Boards and Output Printed Circuit Boards and, therefore, any number of inputs and outputs or combination thereof. Further, the depicted and described preferred embodiment of the invention is exemplary only, and is not exhaustive of the scope of the invention. Consequently, the invention is intended to be limited only by the spirit and scope of the appended claims, giving full cognizance to equivalents in all respects.

What is claimed is:

1) A matrix switcher comprising:
a plurality of input printed circuit boards disposed in a way that their planes are substantially parallel to each other;
a plurality of output printed circuit boards, disposed in a way that their planes are substantially parallel to each other and at the same time substantially perpendicular to the planes of said input printed circuit boards;
each of said input printed circuit boards comprising a matrix input and a number of outputs, said matrix inputs are connected to said outputs;
each of said output printed circuit boards comprising a number of inputs, a number of switches and a matrix output so that each of the inputs is connected to one of the switches and each of the switches is connected to the matrix output;
each of said outputs is connected to one of said inputs;
said switches can be placed in an “on” position and in an “off” position, so that when placed in the “on” position, the switch permits a signal to pass through it, while in the “off” position, the switch does not permit a signal to pass through it, thus permitting the signal from any of said matrix inputs to be sent to any of said matrix outputs via the corresponding switches placed in the “on” position.

2) A matrix switcher comprising:
a plurality of input printed circuit boards disposed in a way that their planes are substantially parallel to each other;
a plurality of output printed circuit boards, disposed in a way that their planes are substantially parallel to each other and at the same time substantially perpendicular to the planes of said input printed circuit boards;
each of said input printed circuit boards comprising a matrix input, a number of switches and a number of outputs so that each of the outputs is connected to one of the switches and each of the switches is connected to the matrix input;
each of said output printed circuit boards comprising a number of inputs and a matrix output, said inputs are connected to said matrix output;
each of said outputs is connected to one of said inputs;
said switches can be placed in an “on” position and in an “off” position, so that when placed in the “on” position, the switch permits a signal to pass through it, while in the “off” position, the switch does not permit a signal to pass through it, thus permitting the signal from any of said matrix inputs to be sent to any of said matrix outputs via the corresponding switches placed in the “on” position.
